(19) United States
(12) Patent Application Publication
(10) Pub. No.: US 2004/0260766 A1
(43) Pub. Date: Dec. 23, 2004

(54) System for location based internet access and method therefore

(76) Inventors: Mark A. Barros, Wellington, FL (US); Diana M. Arboleda, Delray Beach, FL (US); James A. Hymel, Lake Worth, FL (US)

Correspondence Address: Randi L. Dulaney, Motorola, Inc., Law Department, 8000 West Sunrise Boulevard, Fort Lauderdale, FL, 33322, US

(21) Appl. No.: 10/464,390

(22) Filed: Jun. 18, 2003

(51) Int. Cl. G06F 15/16

(52) U.S. Cl. 709/203; 709/218

(57) ABSTRACT

A system (200) for location based Internet access includes at least one device (500) having a current location (560). The device (500) includes a browser application (560) adapted to access one or more Internet websites associated with one or more location specific navigational paths. The browser application (560) uses one or more current navigational paths (565) which are associated with the current location (560). The device (500) is adapted to change the utilized one or more current navigational paths (565) when the current location (560) changes.

### BACKGROUND OF THE INVENTION

1. Field of the Invention

This invention relates in general to electronic devices and more particularly to communication devices with Internet access capability.

2. Description of the Related Art

Worldwide communication capabilities made possible by the technology revolution of the past decade has created a truly global environment. For example, the Internet has created a global shopping mall and information retrieval network for anyone with access. The Internet is collection of over 25,000 computer networks connected through a communication backbone (NSFNET backbone) funded by the National Science Foundation (NSF) and is currently managed by Advanced Network System (ANS). A subscriber obtains an account with an organization's host computer (server) that is connected to the Internet through one or more networks. Traditionally, the subscriber is connected to the server through telephone lines using a personal computer (PC) and a modem. Each website is identified by a unique navigational path such as a universal resource locator (URL). URLs are short strings that identify resources in the Internet computer network including documents, images, downloadable files, services, electronic mailboxes, and other resources. They make resources available under a variety of naming schemes and access methods (such as HTTP (Hypertext Transfer Protocol), FTP (File Transfer Protocol), and Internet protocol) mail addressable in the same simple way. A URL includes the protocol (ex. HTTP or FTP), the domain name (or IP address), and additional path information (folder/file). On the Web, a URL may address a Web page file, image file, or any other file supported by the HTTP protocol.

The World Wide Web continues to evolve beyond its original intent. Technologies and services offered are constantly changing based on needs of the Internet community and the emergence of new technologies. Web addresses (URLs) are typically long making them difficult to type and equally challenging to memorize. Search engines exist to assist users in locating relevant content based on keywords.

Internet enabled devices are now taking various forms. The modern consumer, for example, can access the Internet on any number of electronic devices such as a dedicated pocket messaging assistant, a personal computer, an electronic pocket organizer, a laptop computer, a personal digital assistant, or the like. Similarly, the modern consumer can access the Internet on various electronic communication devices such as a mobile cellular telephone, a mobile radio data terminal, a mobile cellular telephone having an attached data terminal, a personal computer having a communication means either built in or attached, or a two way messaging device. With Internet access now available for general consumption in a multitude of forms, new opportunities exist to take advantage of the mobility these platforms provide.

Recently some communication devices incorporate the capability to determine device location. For example, a communication system can use direction finding equipment at each base station site in order to fix the location of each communication device. The current device location is computed by triangulation when two or more transmitter base stations receive the same signal. Similarly, the communication device can include a Global Positioning System (GPS) receiver for determining its current location. The Global Positioning System (GPS) is a worldwide radio-navigation system formed from a constellation of twenty four (24) satellites and their ground stations. GPS uses these “man-made stars” as reference points to calculate positions accurate to a matter of meters. The GPS receiver uses the satellites in space as reference points for locations here on earth. The GPS receiver measures distance using the travel time of radio signals. The GPS receiver has very accurate timing to measure travel time. Along with distance, the GPS receiver knows exactly where the satellites are in space. Finally, the GPS receiver corrects for any delays the signal experiences as it travels through the atmosphere.

### BRIEF DESCRIPTION OF THE DRAWINGS

The accompanying figures, where like reference numerals refer to identical or functionally similar elements throughout the separate views and which together with the detailed description below, are incorporated in and form part of the specification, serve to further illustrate various embodiments and to explain various principles and advantages all in accordance with the present invention.

FIG. 1 is an electronic block diagram illustrating a communication system.

FIG. 2 is an electronic block diagram of a location based Internet access system for use with the communication system of FIG. 1.

FIG. 3 is an electronic block diagram of location based Internet access server for use within the systems of FIGS. 1 and 2.

FIG. 4 is a flowchart illustrating one embodiment of the operation of the location based Internet access server of FIG. 3.

FIG. 5 is an electronic block diagram of a communication device for use within the system of FIGS. 1 and 2.

FIG. 6 is a flowchart illustrating one embodiment of the operation of the communication device of FIG. 5.

### DETAILED DESCRIPTION OF THE PREFERRED EMBODIMENT(S)

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

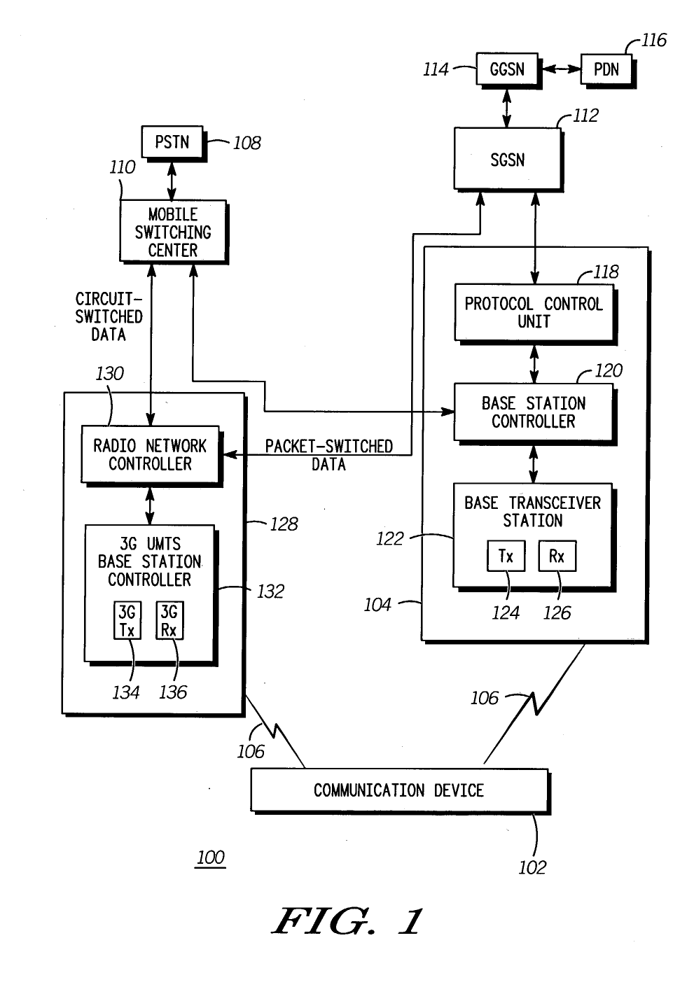

FIG. 1 is an electronic block diagram of a communication system 100. As illustrated in FIG. 1, the communication system 100 includes a communication device 102, such as a wireless telephone device, capable of either second generation Global System for Mobile Communications (GSM) data interchange or third generation Universal Mobile Telephone System (UMTS) data interchange, or both. For example, the communication device 102 transmits circuit-switched data through an air interface 106 to and receives circuit-switched data through the air interface 106 from a second generation GSM General Packet Radio Service (GPRS) and Enhanced Data for Global Evolution (EDGE), GSM GPRS/EDGE radio access network 104. The circuit-switched data is transmitted by radio access network 104 from the communication device 102 to a public switched telephone network (PSTN) 108, and from the public switched telephone network 108 to the communication device 102, through a mobile switching center 110.

The communication device 102 transmits packet-switched data through the air interface 106 to, and receives packet-switched data through the air interface 106 from the radio access network 104. The packet-switched data received from the communication device 102 is transmitted by the radio access network 104 to a serving GPRS support node (SGSN) 112, which then transmits the packet-switched data to a gateway GPRS support node (GGSN) 114. The gateway GPRS support node 114 converts the packet-switched data from a domain associated with the radio access network 104 to a domain associated with a packet data network 116 and transmits the converted packet-switched data to packet data network 116.

Similarly, packet-switched data received from the packet data network 116 is converted by the gateway GPRS support node 114 from the domain associated with the packet data network 116 to the domain associated with the radio access network 104. The converted packet-switched data is then transmitted from the gateway GPRS support node 114 to the radio access network 104 through the GPRS support node 112. The radio access network 104 then transmits the packet-switched data to the communication device 102 along the air interface 106.

The radio access network 104 preferably includes a protocol control unit 118, a base station controller 120, and a base transceiver station. The protocol control unit 118 interfaces between the GPRS support node 112 and the base station controller 120, which controls the packet-switched data that is transmitted between the packet data network 116 and the communication device 102. The base station controller 120 controls one or more base transceiver stations, including the base transceiver station 122 located within the radio access network 104. The base transceiver station 122 includes a transmitter 124 and a receiver 126 for transmitting and receiving data between the communication device 102 and the radio access network 104 along the air interface 106. The base station controller 120 transmits packet-switched data received from the packet data network 116 via the protocol control unit 118 to the base transceiver station 122, which then transmits the packet-switched data to the communication device 102 along the air interface 106. In the same way, the base station controller 120 transmits packet-switched data received from the communications device 102 via the base transceiver station 122 to the protocol control unit 118. The packet-switched data is then transmitted from the protocol control unit 118 to the packet data network 116 through the serving GPRS support node 112 and the gateway GPRS support node 114.

In addition to receiving packet-switched data exchanged between the packet data network 116 and the communication device 102, the base station controller 118 receives circuit-switched data transmitted from the public switched telephone network 108 to the communication device 102 through the mobile switching center 110, and transmits the circuit-switched data to the base transceiver station 122. The circuit-switched data is then transmitted from the base transceiver station 122 to the communication device 102 along the air interface 106.

The base transceiver station 122 transmits circuit-switched data received from the communication device 102 for transmission to the public switched telephone network 108 to the base station controller 120, and the circuit-switched data is then transmitted from the base station controller 120 to the mobile switching center 110, which then transmits the circuit-switched data to the public switch telephone network 108.

In this way, in one embodiment, the communication system 100 includes the communication device 102, the radio access network 104 and the mobile switching center 110, with the communication device 102 being capable of transmitting and receiving circuit-switched data along a circuit-switched data path between the communication device 102 and the public switched telephone network 108 through the mobile switching center 110, the radio access network 104 and the air interface 106.

Similarly, in a second embodiment, the communication system 100 includes the communication device 102, the radio access network 104, the serving GPRS support node 112 and the gateway GPRS support node 114, with the communication device 102 being capable of transmitting and receiving packet-switched data along a packet-switched data path between the communication device 102 and the packet data network 116 through the gateway GPRS support node 114, the serving GPRS support node 112, the radio access network 104 and the air interface 106.

According to a third embodiment, the communication system 100 includes the communication device 102, the radio access network 104, the mobile switching center 110, the serving GPRS support node 112 and the gateway GPRS support node 114. As a result, the communication device 102 is capable of transmitting and receiving circuit-switched data along a circuit-switched data path between the communication device 102 and the public switched telephone network 108, through the mobile switching center 110 and the radio access network 104. In addition, the communication device 102 is also capable of transmitting and receiving packet-switched data along a packet-switched path between the communication device 102 and the packet data network 116 through the gateway GPRS support node 114, the serving GPRS support node 112, the radio access network 104 and the air interface 106.

As illustrated in FIG. 1, the communication device 102 transmits circuit-switched data through the air interface 106 to, and receives circuit-switched data through the air interface 106 from a third generation UMTS radio access network 128. Circuit-switched data received from the communication device 102 is transmitted by the third generation UMTS radio access network 128 to the public switched telephone network 108 through the mobile switching center 110, and circuit-switched data received from the public switched telephone network 108 through the mobile switching center 110 is transmitted by the third generation UMTS radio access network 128 to the communication device 102. The communication device 102 transmits packet-switched data through the air interface 106 to, and receives packet-switched data through the air interface 106 from the third generation UMTS radio access network 128. The packet-switched data received by the third generation UMTS radio access network 128 from the communication device 102 is transmitted by the third generation UMTS radio access network 128 to the serving GPRS support node 112, which then transmits to the packet-switched data to the gateway GPRS support node (GGSN) 114. The gateway GPRS support node 114 converts the packet-switched data from a domain associated with the third generation UMTS radio access network 128 to a domain associated with the packet data network 116 and transmits the converted packet-switched data to the packet data network 116.

Similarly, packet-switched data received from the packet data network 116 is converted by the gateway GPRS support node 114 from the domain associated with the packet data network 116 to the domain associated with the radio access network 104. The converted packet-switched data is then transmitted from the gateway GPRS support node 114 to the third generation UMTS radio access network 128 through the GPRS support node 112. The third generation UMTS radio access network 128 then transmits the packet-switched data to the communication device 102 along the air interface 106.

Preferably, the third generation UMTS radio access network 128 includes a radio network controller 130 that is capable of discerning between the packet-switched data domain and the circuit-switched data domain to enable interface between the third generation UMTS radio access network 128 and both the packet data network 116 and the public switched telephone network 108. As a result, the third generation UMTS radio access network 128 interfaces with the serving GPRS support node 112 and the mobile switching center 110, with the radio network controller 130 controlling packet-switched data that is transmitted between the packet data network 116 and the communication device 102 and circuit-switched data that is transmitted between the public switched telephone network 108 and the communication device 102.

In particular, the radio network controller 130 interfaces with a third generation UMTS base station controller 132 located within the third generation UMTS radio access network 128 that includes a third generation UMTS transmitter 134 and a third generation UMTS receiver 136 for transmitting and receiving data transmitted between the communication device 102 and the third generation UMTS radio access network 128 along the air interface 106. The third generation UMTS radio network controller 130 transmits packet-switched data received from the packet data network 116, through the serving GPRS support node 112 and the gateway GPRS support node 114, to the third generation UMTS base station controller 132, which then transmits the packet-switched data to the communication device 102 along the air interface 106. The third generation UMTS radio network controller 130 transmits packet-switched data received from the communication device 102 via the third generation UMTS base station controller 132 to the packet data network 116 through the serving GPRS support node 112 and the gateway GPRS support node 114. In the same way, the third generation UMTS radio network controller 130 transmits circuit-switched data received from the public switched telephone network 108, through the mobile switching center 110, to the third generation UMTS base station controller 132, which then transmits the circuit-switched data to the communication device 102 along the air interface 106. Finally, the third generation UMTS radio network controller 130 transmits circuit-switched data received from the communication device 102 via the third generation UMTS base station controller 132 to the public switched telephone network 108 through mobile switching center 110.

In this way, according to a fourth embodiment, the communication system 100 includes the communication device 102, the third generation UMTS radio access network 128 and the mobile switching center 110, with the communication device 102 being capable of transmitting and receiving circuit-switched data along a circuit-switched data path between the communication device 102 and the public switched telephone network 108 through the mobile switching center 110, the third generation UMTS radio access network 128 and the air interface 106.

According to a fifth embodiment, the communication system 100 includes the communication device 102, the third generation UMTS radio access network 128, the serving GPRS support node 112 and the gateway GPRS support node 114, with the communication device 102 being capable of transmitting and receiving packet-switched data along a packet switched data path between the communication device 102 and the packet data network 116 through the gateway GPRS support node 114, the serving GPRS support node 112, the third generation UMTS radio access network 128 and the air interface 106.

According to a sixth embodiment, the communication system 100 includes the communication device 102, the third generation UMTS radio access network 128, the mobile switching center 110, the serving GPRS support node 112 and the gateway GPRS support node 114. As a result, the communication device 102 is capable of transmitting and receiving circuit-switched data along a circuit-switched data path between the communication device 102 and the public switched telephone network 108, through the mobile switching center 110 and the third generation UMTS radio access network 128, and is also capable of transmitting and receiving packet-switched data along a packet-switched path between the communication device 102 and the packet data network 116 through the gateway GPRS support node 114, the serving GPRS support node 112, the third generation UMTS radio access network 128 and the air interface 106.

According to a seventh embodiment, the communications system 100 includes the communication device 102, the radio access networks 104 and 128, the mobile switching center 110, the serving GPRS support node 112 and the gateway GPRS support node 114. The communication device 102 is capable of transmitting and receiving circuit-switched data along a circuit-switched data path between the communication device 102 and the public switched telephone network 108, through the mobile switching center 110 and the radio access network 104. In addition, the communication device 102 is also capable of transmitting and receiving packet-switched data along a packet-switched path between the communication device 102 and the packet data network 116 through the gateway GPRS support node 114, the serving GPRS support node 112, the radio access network 104 and the air interface 106. Furthermore, the communication device 102 is capable of transmitting and receiving circuit-switched data along a circuit-switched data path between the communication device 102 and the public switched telephone network 108, through the mobile switching center 110 and the third generation UMTS radio access network 128. Further, the communication device 102 is also capable of transmitting and receiving packet-switched data along a packet-switched path between the communication device 102 and the packet data network 116 through the gateway GPRS support node 114, the serving GPRS support node 112, the third generation UMTS radio access network 128 and the air interface 106.

As a result, the present invention provides a multiple air interface, corresponding to the seven embodiments described above, that enables network access by the communication device 102 along either the circuit-switched path or the packet-switched path from the communication device 102 to the public switched telephone network 108 and the packet data network 116, respectively, or both, and through either second generation GSM GPRS/EDGE radio access network 104 or third generation UMTS radio access network 128, or both.

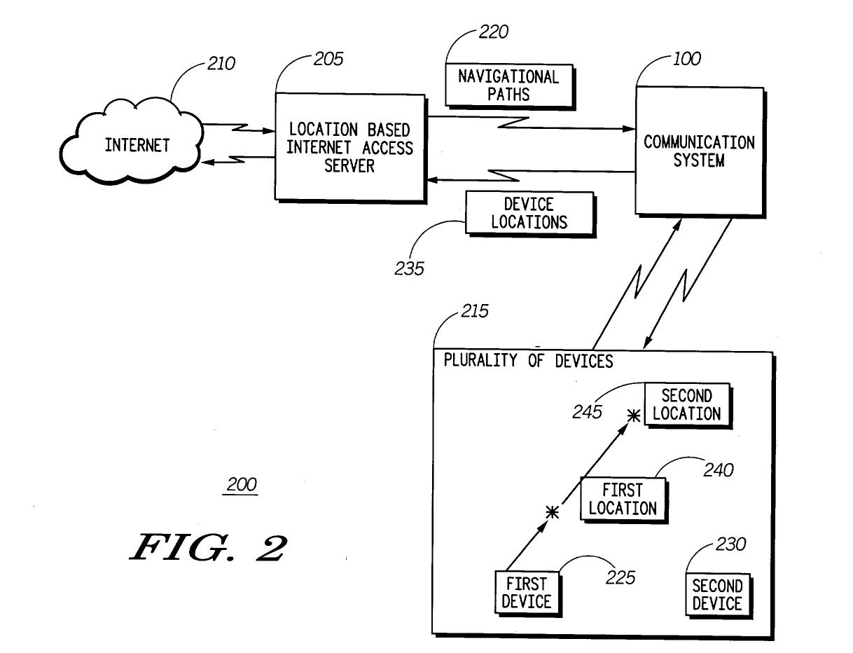

FIG. 2 is an electronic block diagram of a location based Internet access system 200 for use with the communication system 100 of FIG. 1. As illustrated in FIG. 2, the location based Internet access system 200 preferably includes a location based Internet access server 205 coupled between the communication system 100 (such as illustrated in FIG. 1) and an Internet 210. The communication system 100 is further coupled between the location based Internet server 205 and a plurality of devices 215. The location based Internet access server 205 controls and manages communication of one or more navigational paths 220 to the plurality of devices 215 such as the first device 225 and the second device 230. The first device 225 and the second device 230 can be, for example, the communication device 102 of FIG. 1. The location based Internet server 205, identifies location specific navigational paths associated with one or more device locations 235 for one or more of the plurality of devices 215. For example, the first device 225 can be at a first location 240 and then later move to a second location 245. Each of the first location 240 and the second location 245 is communicated to the location based Internet access server 205 via the communication system 100 along with a request for associated navigational paths.

The navigational path can include, for example, a Uniform Resource Locator (URL) for a retail establishment at the current location of the device. URLs are short strings that identify resources in the Internet 210 including documents, images, downloadable files, services, electronic mailboxes, and other resources. URLs make resources available under a variety of naming schemes and access methods (such as HTTP (Hypertext Transfer Protocol), FTP (File Transfer Protocol), and Internet protocol) mail addressable.

As an example, when the first device 225 is at the first location 240 which is a restaurant, the Internet navigational path for that restaurant can be sent to the first device 225. The Internet navigational path for the restaurant is then available to the device user at the first location. When the first device 225 leaves the first location 240 and arrives at the second location 245 which is a retail establishment, the Internet navigational path for that retail establishment can be sent to the first device 225. The Internet navigational path for the retail establishment is then available to the device user at the second location 245. This process thus gives each device user access to contextually relevant Internet websites in real time.

The detection and notification of the device location of each of the plurality of communication devices 215 can be done by either the device itself, the communication system 100, or the location based Internet access server 205 as is well know to those of ordinary skill in the art. For example, in a system using the ReFLEX protocol, each radio tower is assigned a ‘Color Code’, which is embedded in the frame synchronization word broadcasted to the plurality of devices. The device can determine its relative location by comparing the current color code against an earlier color code. Similarly, in the GSM protocol, the Base Identification Code (BSIC) broadcasted on the SCH of every cell allows a mobile station to distinguish among neighboring cells. Alternatively, the system can use a very high-frequency omni directional range (VOR), which is used primarily as a navigation aid for aircraft compares the phase of a fixed and rotating signal to compute its angle with respect to a transmitter station. In a VOR system, a transmitter emits a (variable) modulation whose phase relative to a reference modulation is different for each bearing of the receiving point from the station. The typical radio frequency (RF) bandwidth required for a VOR system is around 25 kilohertz (KHz). Alternatively, a location for each device can be determined using the Global Positioning System (GPS). The Global Positioning System is a worldwide radio-navigation system formed from a constellation of 24 satellites and their ground stations. GPS uses these “man-made stars” as reference points to calculate positions accurate to a matter of meters. The satellites in space such as the satellite 54 are used as reference points for locations here on earth. It will be appreciated by one of ordinary skill in the art that the location based Internet access system 200, in accordance with the present invention, can determine the location of the plurality of devices using the location determining methods mentioned above or an equivalent.

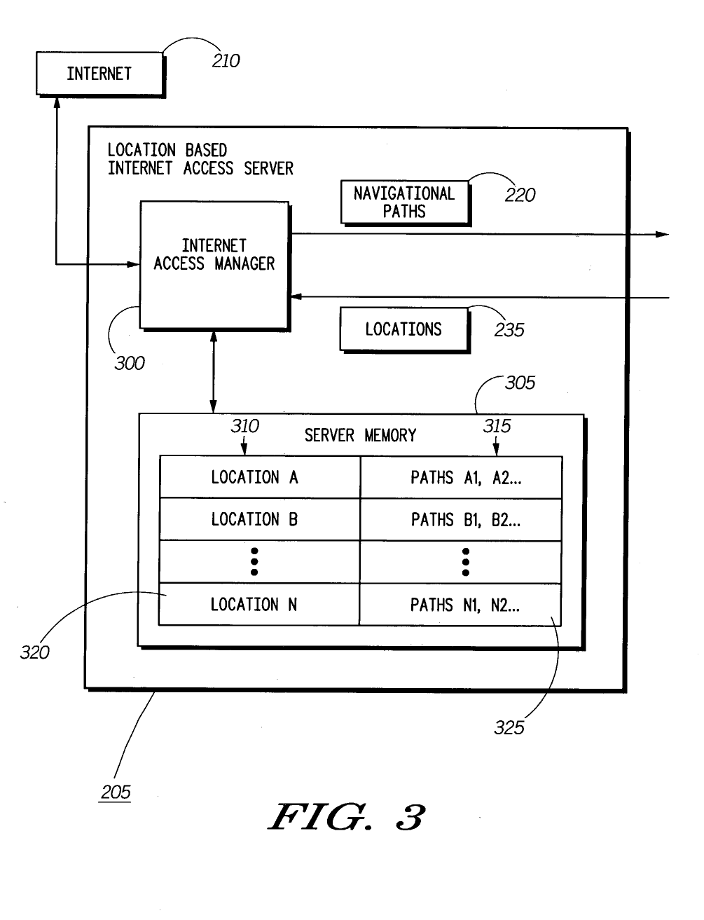

FIG. 3 is an electronic block diagram of one embodiment of the location based Internet access server 205 for use within the systems of FIGS. 1 and 2. As illustrated, the location based Internet access server 205 preferably includes an Internet access manager 300 and a server memory 305.

The Internet access manager 300 can be hard coded or programmed into the location based Internet access server 205 during manufacturing, can be programmed over-the-air upon customer subscription, or can be a downloadable application. It will be appreciated that other programming methods can be utilized for programming the Internet access manager 300 into the location based Internet access server 205. It will be further appreciated by one of ordinary skill in the art that the Internet access manager 300 can be hardware circuitry within the location based Internet access server 205. The Internet access manager 300 is adapted to identify one or more Internet navigational paths associated with one or more locations. The Internet access manager 300 is coupled to the server memory 305 for accessing pre-stored Internet navigational paths associated with a desired location. The server memory 305 stores a plurality of predetermined locations 310 along with associated location specific Internet navigational paths 315. For example, when the Internet access manager 300 receives a request for one or more location specific Internet navigational paths 325 associated with an Nth location 320, the Internet access manager 300 can retrieve the one or more location specific Internet navigational paths 325 from the server memory 305. The Internet access manager 300 is further coupled to the Internet 210 for retrieving location specific Internet navigational paths. When the Internet access manager 300 receives a request for Internet navigational paths associated with a new location not stored in the server memory 305, the Internet access manager 300 can retrieve such information directly through the Internet 210, for example, by accessing an Internet search engine. The Internet access manager 300 can thereafter store the new location and resultant new Internet navigational paths within the server memory 305 for future utilization.

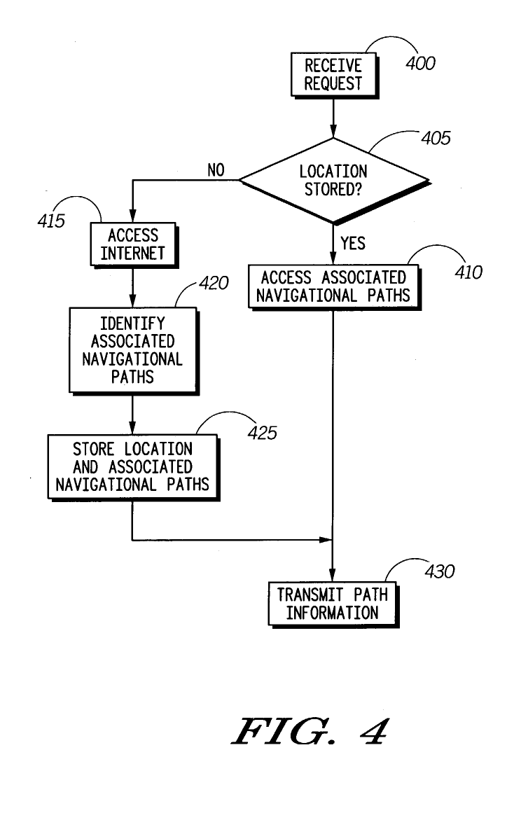

FIG. 4 is a flowchart illustrating one embodiment of the operation of the location based Internet access server 205 of FIGS. 2 and 3. Specifically, FIG. 4 illustrates an exemplary embodiment of processing a request received by the Internet management server 205. The operation begins with Step 400 in which the location based Internet access server 205 receives a request. The request, for example, can be a request sent from one of the plurality of devices 215 via the communication system 100 for location specific Internet navigational paths 325 associated with the device's current location. In one embodiment, the request includes the device's current location. Alternatively, the location based Internet access server 205 can determine the device's location either via the communication server 100 or some other method as described previously herein. Next, in Step 405, the Internet access manager 300 of the location based Internet access server 205 determines whether the device's location is one of the plurality of predetermined locations 310 stored in the server memory 305 along with associated location specific Internet navigational paths 315. When the device's location is one of the plurality of predetermined locations 310 stored in the server memory 305 along with associated location specific Internet navigational paths 315, the operation continues with Step 410. In Step 410, the Internet access manager 300 accesses the one or more navigational paths associated with the device's location. For example, when the device's location is the Nth location 320, the Internet access manager 300 accesses the one or more location specific Internet navigational paths 325.

Alternatively, when the device's location is not one of the plurality of predetermined locations 310 stored in the server memory 305, the operation continues with Step 415. In Step 415, the Internet access manager 300 accesses the Internet 210 through one or more communication blocks (not shown in FIG. 3) of the location based Internet access server 205. For example, the location based Internet access server 205 can include capabilities for accessing the Internet 210 via a connected short range wireless local area network utilizing any short range wireless protocol such as Bluetooth, IrDA, HomeRF, and IEEE 802.11. Similarly, the location based Internet access server 205 can include capabilities to access a physical network such as ARCNET, Ethernet, Token-ring, Local Talk or other network media. The location based Internet access server 205 can operate on a LAN that employs any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures to enable the communication among the devices and/or between the devices and the shared resources. Further, the location based Internet access server 205 can operate on a WAN that uses a different physical network media such as X.25, Frame Relay, ISDN, Modem dial-up or other media to connect other computers or other local area networks to access the Internet 210. Further, the location based Internet access server 205 can function utilizing any wireless RF channel, for example, a one or two-way pager channel, a mobile cellular telephone channel, or a mobile radio channel to access the Internet 210. It will be appreciated by those of ordinary skill in the art that any combination of access capabilities can be used to access the Internet 210 in accordance with the present invention.

Next, in Step 420, the Internet access manager 300 identifies navigational paths associated with the device's location. For example, the Internet access manager 300 can access a search engine on the Internet to determine navigational paths associated with the device's location such as a restaurant with the same mailing address. Alternatively, the Internet access manager 300 can be programmed with a custom search engine for matching navigational paths with the device's location. Alternatively, the Internet access manager 300 can access a managed database containing links (navigation paths) and locations (GPS positions). It will be appreciated by those of ordinary skill in the art that the managed database can be stored within the location based Internet access server 205, within the Internet 210 itself, or any other memory storage device in accordance with the present invention. When the user request the link to his/her current location, the corresponding URL is sent back and opened by the owner's browser. Next, in Step 425, the device's location and the identified associated navigational paths are stored in the server memory 305 for future reference. Next, and after accomplishing Step 410, the identified location specific Internet navigational paths are transmitted to the requesting device via the communication system 100 in Step 430.

The above described operation provides a unique method for associating physical and/or geographic locations with URLs and using this information to launch web page content relevant to a user's physical location. Since web addresses are typically lengthy and non-intuitive, it can be difficult for the user to manually enter into a device and equally challenging to memorize. The method as described above allows the device user to take advantage of additional mobility in Internet accessibility.

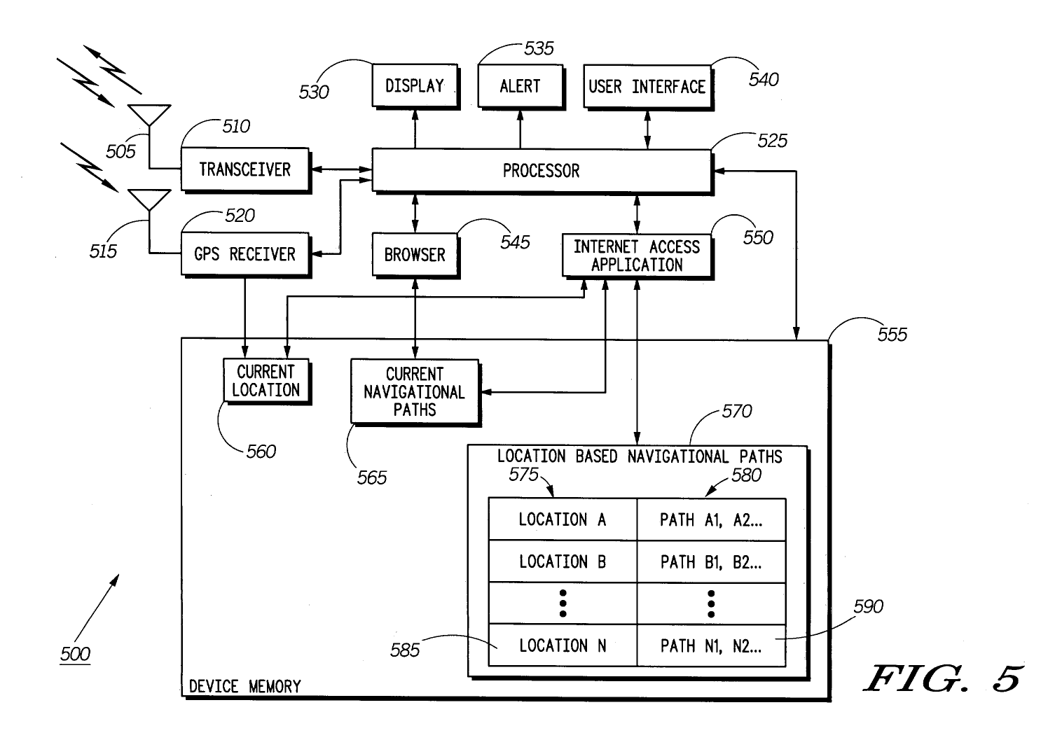

FIG. 5 is an electronic block diagram of a communication device 500 for use within the system of FIGS. 1 and 2. The communication device 500, for example, can be the communication device 102 of FIG. 1, and/or one of the plurality of devices 215 of FIG. 2 such as the first device 225 and/or the second device 230. It will be appreciated by one of ordinary skill in the art that the communication device in accordance with the present invention can be a personal computer, a personal digital assistant, or the like having communications capability. Further, it will be appreciated by one of ordinary skill in the art that the communication device, in accordance with the present invention, can be a mobile cellular telephone, a mobile radio data terminal, a mobile cellular telephone having an attached data terminal, or a two way pager. Further can be a small portable personal computer having wireless communications capability. In the following description, the term “communication device” refers to any of the devices mentioned above or an equivalent.

As illustrated, the communication device 500 preferably includes an antenna 505, a transceiver 510, a GPS antenna 515, a GPS receiver 520, a processor 525, a device memory 555, an alert circuit 535, a display 530, a user interface 540, a browser 545, and an Internet access application 550.

The antenna 505 intercepts transmitted signals from a communication system and transmits signals to the communication system. The antenna 505 is coupled to the transceiver 510, which employs conventional demodulation techniques for receiving the communication signals. The transceiver 510 is coupled to the processor 525 and is responsive to commands from the processor 525. When the transceiver 510 receives a command from the processor 525, the transceiver 510 sends a signal via the antenna 505 to the communication system. In an alternative embodiment (not shown), the communication device 500 includes a receive antenna and a receiver for receiving signals from the communication system and a transmit antenna and a transmitter for transmitting signals to the communication system. It will be appreciated by one of ordinary skill in the art that other similar electronic block diagrams of the same or alternate type can be utilized for the communication device 500.

Coupled to the transceiver 510, is the processor 525 utilizing conventional signal-processing techniques for processing received messages. It will be appreciated by one of ordinary skill in the art that additional processors can be utilized as required to handle the processing requirements of the processor 525. The processor 525 decodes an address in the demodulated data of a received message, compares the decoded address with one or more addresses stored in the device memory 555, and when a match is detected, proceeds to process the remaining portion of the received message.

To perform the necessary functions of the communication device 500, the processor 525 is coupled to the device memory 555, which preferably includes a random access memory (RAM), a read-only memory (ROM), and an electrically erasable programmable read-only memory (EEPROM)(not shown). It will be appreciated by those of ordinary skill in the art that the device memory 555 can be integrated within the communication device 500, or alternatively can be at least partially contained within an external memory such as a memory storage device. Preferably, the device memory 555 includes memory locations for storing a current location 560, one or more current navigational paths 565, and one or more location based navigational paths 570.

Upon receipt and processing of a message or a call, the processor 525 preferably generates a command signal to the alert circuit 535 as a notification that the message has been received and stored or alternatively that a call is waiting for a response. The alert circuit 535 similarly can be utilized for other alerting notifications such as an alarm clock or a change in the current location 560. The alert circuit 535 can include a speaker (not shown) with associated speaker drive circuitry capable of playing melodies and other audible alerts, a vibrator (not shown) with associated vibrator drive circuitry capable of producing a physical vibration, or one or more light emitting diodes (LEDs) (not shown) with associated LED drive circuitry capable of producing a visual alert. It will be appreciated by one of ordinary skill in the art that other similar alerting means as well as any combination of the audible, vibratory, and visual alert outputs described can be used for the alert circuit 535.

Upon receipt and processing of a message or a received call, the processor 525 preferably also generates a command signal to the display 530 to generate a visual notification. Similarly, the display 530 can be utilized as a means for providing information to the device user. For example, the current navigational paths 565 and/or the current location 560 can be displayed on the display 530. The display can be a liquid crystal display, a cathode ray tube display, one or more organic light emitting diodes, one or more LEDs, a plasma display, or an equivalent.

Preferably, the user interface 540 is coupled to the processor 525. The user interface 540 can include a keypad such as one or more buttons used to generate a button press or a series of button presses. The user interface 540 can also include a voice response system or other similar method of receiving a manual input initiated by the device user. The processor 525, in response to receiving a user input via the user interface 540 performs commands as required. As an example, and in accordance with the present invention, the user interface 540 can include a “my location” button. When the “my location” button is pressed, the processor 525 can cause the current location 560 of the communication device 500 to be updated by determining the device's current coordinate location (via the GPS antenna 515 and the GPS receiver 520 for example). The processor 525 similarly can determine the current navigational paths 565 associated with the current location 560. The user interface 540 can further be utilized to launch one or more of the websites associated with the one or more current navigational paths 565.

The GPS receiver 520 is preferably coupled to the GPS antenna 515 and the processor 525 and is capable of processing Global Positioning System signals. It will be appreciated by those of ordinary skill in the art that one or more location information can be provided through other means including; triangulation from cellular wide area networks and triangulation from local area networks in and out of buildings. The communication device 500 can decode the location information and store the location information as the current location 560 in the device memory 555.

In a preferred embodiment, the communication device 500 includes the browser application 545. The browser application 545 can be hard coded or programmed into the communication device 500 during manufacturing, can be programmed over-the-air upon customer subscription, or can be a downloadable application. It will be appreciated that other programming methods can be utilized for programming the browser application 545 into the communication device 500. It will be further appreciated by one of ordinary skill in the art that the browser application 545 can be hardware circuitry within the communication device 500.

The browser application 545 preferably provides functionality for a device user to find and view information available on the Internet 210 via the communication system 100. The browser application 545, for example can be a text-based browser using “point-and-click” graphical manipulations. The browser application 545 can preferably interpret the Hyper Text Markup Language (HTML) tags in downloaded documents and format the displayed data according to a set of standard style rules. The browser application 545 is coupled to the processor 525 for accessing various Internet websites associated with the current navigational paths 565 in response to a user input to the user interface 540 as described previously herein.

In a preferred embodiment, the communication device 500 includes the Internet access application 550. The Internet access application 550 can be hard coded or programmed into the communication device 500 during manufacturing, can be programmed over-the-air upon customer subscription, or can be a downloadable application. It will be appreciated that other programming methods can be utilized for programming the Internet access application 550 into the communication device 500. It will be further appreciated by one of ordinary skill in the art that Internet access application 550 can be hardware circuitry within the communication device 100.

In one embodiment of the present invention, the Internet access application 550, coupled between the processor 525 and the device memory 555, is adapted to identify the one or more current navigational paths 565 associated with the current location 560. The Internet access application 550 is further adapted to access the location based navigational paths 570 stored within the device memory 555 in response to a processor command, a timer timeout, or any other predetermined event. The processor command, for example, can be generated by the processor 525 in response to a change in the current location 560, a user input to the user interface 540, and the like. The Internet access application 550 retrieves the current location and compares it to a list of stored locations 575 having associated stored navigational paths 580 of the location based navigational paths 570 in the device memory 555. For example, when the current location 560 is the Nth location 585, the Internet access application can retrieve the Nth location based navigational paths 590 from the device memory and thereafter store them within the current navigational paths 565. Alternatively, when the current location 560 is not included within the plurality of stored locations 575, the Internet access application 550 sends a command to the processor 525 requesting retrieval of the location specific Internet navigational paths associated with the current location 560 from the Internet 210. The Internet access application 550 can retrieve such information directly through the Internet 210, for example, by accessing an Internet search engine via the browser application 545. The Internet access application 550 can thereafter store the new location and resultant new Internet navigational paths within the device memory 555 for future utilization. Alternatively, the Internet access application 550 can include a customized search engine which can retrieve location based navigational paths from the Internet using the current location 560. As illustrated and described in FIGS. 2, 3 and 4, alternatively, the Internet access application 550 can generate a request via the communication system 100 to the location based Internet access server 205 for the location based navigational paths associated with the current location 560.

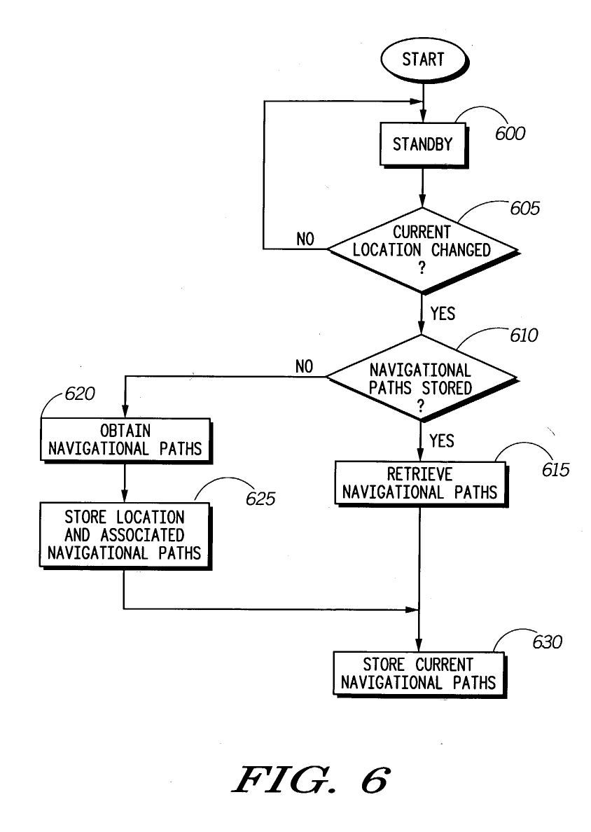

FIG. 6 is a flowchart illustrating one embodiment of the operation of the communication device 500 in accordance with the present invention. Specifically, FIG. 6 illustrates an exemplary embodiment of the operation of the Internet access application 550 of the communication device 500. As illustrated, the process begins with Step 600 in which the communication device 500 is in standby mode. Standby mode runs the communication device 500 with minimal power to conserve battery life. Next, in Step 605, the Internet access application 550 periodically checks whether the current location 560 has changed. For example, the Internet access application 550 can retrieve the latest GPS location coordinates from the GPS receiver 520 through the processor 525 and compare these coordinates the most recent location in which the Internet access application 550 has used to calculate location specific navigational paths. Alternatively, the current location 560 stored in the device memory 555 can be updated periodically by the processor 525 or directly by the GPS receiver 520 and the Internet access application 550 can periodically check for updates. Alternatively, the processor 525 can inform the Internet access application 550 when the current location 560 has been changed. It will be appreciated by those of ordinary skill in the art that any combination of the methods for checking for an updated device location or an equivalent is within the scope of the present invention. When the current location has not changed, the process cycles back to Step 600 and the communication device 500 returns to standby mode. In Step 610, when the current location 560 has changed, the Internet access application 550 determines whether the current location 560 is included within the plurality of stored locations 575 having location based navigational paths 580 stored within the device memory 555. In Step 615, when the current location 560 is included within the plurality of stored locations 575 having location based navigational paths 580 stored within the device memory 555, the Internet access application 550 retrieves the location specific navigational paths. For example, when the current location 560 is the Nth location 585, the Internet access application 550 retrieves the one or more Nth location specific navigational paths 590. In Step 620, when the current location 560 is not included within the plurality of stored locations 575 having location based navigational paths 580 stored within the device memory 555, the Internet access application 550 obtains one or more navigational paths associated with the current location 560 as described previously herein in FIG. 5. For example, the Internet access application 550 can access a managed database containing links (navigation paths) and locations (GPS positions). It will be appreciated by those of ordinary skill in the art that the managed database can be stored within the location based Internet access server 205, within the Internet access application 550, within the Internet 210, or any other memory storage device in accordance with the present invention. Next, in Step 625, the Internet access application 550 stores the current location 560 and the associated location specific navigational paths within the location based navigational paths 570 portion of the device memory 555. Next, and after Step 615, the Internet access application 550 stores the location specific navigational paths associated with the current location 560 within the current navigational paths 565 for utilization and easy access by the browser application 545.

The method as described above can be restated comprising the steps of: identifying a first location of a communication device; associating a first set of Internet navigational paths with the first location; providing the first set of Internet navigational paths to the communication device for accessing the Internet; identifying a second location of the communication device; associating a second set of Internet navigational paths with the second location; and providing the second set of Internet navigational paths to the communication device for accessing the Internet.

The present invention provides a mechanism for a user to utilize the capabilities of location aware devices to readily access websites associated with the user's present location. For example, when the device user presses a “My location” button (similar to the “Home” button on standard web browsers), the device can determine the users current coordinate location (via GPS/EOTD for example), send the current location to a server/database where the coordinate to URL association is made, and launch the corresponding URL. Each time the “My location” button is pressed the user's current location is determined and the corresponding URL is launched allowing him/her to gather a contextually relevant website in a real time manner.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A device for location specific Internet access comprising:
an Internet access application adapted to identify one or more current navigational paths associated with a current location of the device;
a device memory coupled to the Internet access application for storing the current location and the one or more current navigational paths identified by the Internet access application; and
a browser application coupled to the device memory and adapted to access one or more Internet websites associated with the one or more current navigational paths.

2. A device for location specific Internet access as recited in claim 1 wherein the device memory further comprises:
location based navigational path memory for storing one or more locations and one or more associated location specific navigational paths for each stored location,
wherein the Internet access application is further adapted to retrieve the one or more current navigational paths from the location based navigational path memory when the one or more stored locations include the current location.

3. A device for location specific Internet access as recited in claim 1 wherein the Internet access application is adapted to access the Internet to identify the one or more current navigational paths.

4. A system for location based Internet access comprising:
at least one device having a current location, the device comprising:
a browser application coupled to the device memory and adapted to access one or more Internet websites associated with one or more location specific navigational paths; and
a location based Internet access server comprising:
an Internet access manager adapted to:
identify one or more location specific navigational paths associated with the current location in response to receiving a request including the current location from the at least one device, and
send the one or more location specific navigational paths to the at least one device.

5. A system for location based Internet access as recited in claim 4, wherein the at least one device is a communication device, the system further comprising:
a communication system coupled between the communication device and the location based Internet access server.

6. A system for location based Internet access as recited in claim 4, wherein the Internet access server further comprises:
a server memory coupled to the Internet access manager for storing at least one location and associated location specific navigational paths,
wherein the Internet access manager is further adapted to retrieve the one or more location specific navigational paths associated with the current location from the server memory.

7. A system for location based Internet access as recited in claim 4, wherein the Internet access manager is coupled to an Internet for retrieving the one or more location specific navigational paths associated with the current location.

8. A method for location based Internet access comprising the steps of:
communicating a request for location specific Internet navigational paths associated with a current location of a device;
comparing the current location with one or more locations stored with associated location specific Internet navigational paths;
retrieving the associated location specific Internet navigational paths associated with the current location when the current location is one of the stored locations; and
providing the location specific Internet navigational paths associated with the current location for use by the device.

9. A method for location based Internet access as recited in claim 8 wherein the communicating the request step includes communicating the current location.

10. A method for location based Internet access as recited in claim 8 further comprising the step determining the current location of the device after the communicating the request step.

11. A method for location based Internet access as recited in claim 8 further comprising the steps of:
accessing the Internet; and
identifying the location specific Internet navigational paths associated with the current location using the internet when the current location is not one of the stored locations.

12. A method for location based Internet access as recited in claim 11 further comprising the step of:
storing the current location and associated location specific Internet navigational paths in a memory.

13. A method for location based Internet access comprising the steps of:
identifying a first location of a communication device;
associating a first set of Internet navigational paths with the first location;
providing the first set of Internet navigational paths to the communication device for accessing the Internet;
identifying a second location of the communication device;
associating a second set of Internet navigational paths with the second location; and
providing the second set of Internet navigational paths to the communication device for accessing the Internet.
